(19) United States
(12) Patent Application Publication
(10) Pub. No.: US 2008/0193906 A1
(43) Pub. Date: Aug. 14, 2008

(54) Method And Systems For Improving Human Brain Activity To Confront Aging

(75) Inventors: Yitzchak Herman, Jerusalem (IL); Ronny Erez, Jerusalem (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: BRAINSPA LTD., Jerusalem (IL)

(21) Appl. No.: 11/673,580

(22) Filed: Feb. 11, 2007

(51) Int. Cl. G09B 3/00

(52) U.S. Cl. 434/322

(57) ABSTRACT

A method and system for improving human brain activity of individual persons to confront aging comprises evaluating individual existing cognitive skills which identify substantially mentally healthy individuals, referring each substantially healthy individual to an appropriate cognitive skill training program, administering the respective cognitive training program, and, optionally providing additional activities.

### FIELD OF THE INVENTION

The present invention relates to training systems and methods, and in particular to memory enhancement and mind training systems and methods.

### BACKGROUND OF THE INVENTION

Aging postponement—both physical and mental—is a rapidly increasing goal for the middle and upper classes in the developed world The goal is sought after in three major ways: a) the prolongation of life expectancy, b) the growth of financial resources available for this economic class and c) the admiration of youth. As a result, mature people invest a lot of time and money in order to create a high quality of life and preservation of youth, from intensive exercise to alternative medicine. The phenomenon of aging includes not only a decline in physical condition and appearance but also cognitive decline that starts with sporadic forgetfulness and ends with Alzheimer's disease (“Alzheimer”).

Alzheimer is a disease that is increasing in numbers every generation. At present, there are ca. 24 million Alzheimer patients worldwide. In twenty years, this number will double The estimation is that over 10% of those over 65 will suffer from memory lapse and cognitive decline, and different types of dementia including Alzheimer This estimation creates great apprehension among the aging population but also among decision makers in public health because of the heavy financial burden involved in treatment.

The state of the art in brain research shows that the brain is the most elastic organ in the body. Its capacity of reorganization is enormous. Not only do parts of the brain change their function in case of an accident, but neurons, contrary to what we thought in the past, continue to be created all the time throughout a person's life. New circles of connections between neurons are created every time the brain is asked to do or learn a new activity. It is known that people use only a small part of their brain capacity. There is a consensus between brain researches that the enlargement of the brain reserve can be a good answer for the cognitive decline that is determined by aging.

Existing activities that aim to provide solutions to the problems mentioned above include:

1) Development of software for testing of early signs of Alzheimer.

2) Workshops for memory development.

3) Development of software for brain exercises at home.

4) Memory clinics for those diagnosed with the early stages of the disease.

These activities are disadvantageous in that they are generally geared toward unhealthy (i.e. dementia-affected) people and in that they do not provide a solution for healthy people who want to avoid dementia. Consequently there is a need for and it would be advantageous to have a solution that enhances cognitive skills in healthy people and therefore helps postpone and even prevent deterioration of cognitive skills with age.

### SUMMARY OF THE INVENTION

The present invention proposes a variety of activities that cover the different fields of cognitive development. It also proposes a different kind of solution to the problem of the aging-induced cognitive decline. The proposed solution is based on a holistic concept. The solution is preferably implemented within a framework of a facility (hereinafter “system” also referred to as “brain spa”) that is not medical but developmental and educational. In contrast with existing solutions, the system of the present invention is not a memory clinic for treating people with memory disorder, but a place where healthy, mature people can come to improve their brain abilities. The brain spa can therefore be considered a fitness and study center for enhancing cognitive skills.

According to the present invention there is provided a method for improving human brain activity of individual persons to confront aging comprising the steps of: for each individual, evaluating existing cognitive skills which identify substantially mentally healthy individuals, referring the substantially healthy individuals to an appropriate cognitive skill training program, administering to each substantially healthy individual the respective cognitive training program and, optionally providing each substantially healthy individual with additional activities.

In some embodiments of the method, the step of evaluating includes administering a computerized test, administering a sociological test and administering a neurological diagnostic exam.

In some embodiments, the computerized test includes the NexAide test.

In some embodiments, the sociological test includes the Gotlieb test.

In some embodiments of the method, the step of referring includes choosing a number of exercise times per week per individual, creating groups with members having similar verbal capabilities, creating groups of individuals suffering from MCI and recommending additional activities tailored to individual needs.

In some embodiments of the method, the step of administering includes administering an individual cognitive training program and a group cognitive training program.

In some embodiments of the method, the administering an individual cognitive training program includes administering a Mindfit program

In some embodiments of the method, the administering a group cognitive training program includes administering at least one activity selected from the group consisting of an interactive workshop, a memory training workshop, a creativity workshop and a lecture.

In some embodiments of the method, the step of providing each substantially healthy individual with additional activities includes providing each substantially healthy individual with at least one activity selected from the group of a time-management workshop, a support group for aging activity, a foreign language teaching activity and a physical exercise activity.

According to the present invention there is provided a system for improving human brain activity of individual persons to confront aging comprising a physical facility operative to provide cognitive training.

In some embodiments of the system, the physical facility includes a central facility appropriately equipped to perform, for each individual person, cognitive skill evaluation, referral to an appropriate cognitive skill training program and administration of the chosen respective cognitive training program and additional activities.

In some embodiments of the system, the central facility includes a reception area, rooms appropriately fitted to carry out evaluation, referral, administration and training activities, and offices.

### BRIEF DESCRIPTION OF THE DRAWINGS

For a better understanding of the present invention and to show more clearly how it could be applied, reference will now be made, by way of example only, to the accompanying drawings in which:

FIG. 1 shows in a flow chart the main steps of the method of the present invention

FIG. 2 shows details of the evaluation stage of the method in FIG. 1;

FIG. 3 shows details of the choosing of the cognitive training program stage of the method in FIG. 1;

FIG. 4 shows and exemplary brain spa according to the present invention.

### DETAILED DESCRIPTION OF THE INVENTION

The present invention is of a method and system for improving human brain activity to confront aging. In particular, the method and system of the present invention are operative to develop new cognitive skills in an individual, therefore retarding the cognitive decline that increases with age and illness. The method described below is preferably implemented using a unified approach within the physical confines of a “brain spa” (which can be considered the “system” of the present invention). A brain spa of the present invention resembles physical spas dedicated to improving physical well being through physical training activities and treatments. In common with regular health or fitness spas, the brain spa of the present invention may use a for-fee membership business model, or a pay-per-encounter model. The following description uses the membership model in a non-limiting way.

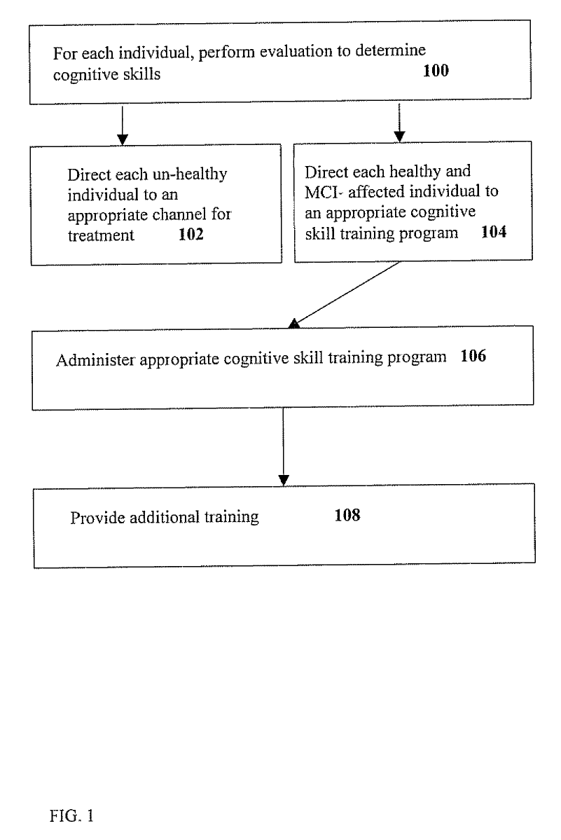

FIG. 1 shows in a flow chart the main steps of the method. In step (or stage) 100, each individual (potential member) undergoes a detailed evaluation to determine existing cognitive skills. The evaluation step is explained in more detail below. As a result of the evaluation, the individual is assigned to one of two groups: non-healthy individuals and healthy individuals. Non-healthy individuals may for example be individuals that suffer from a beginning of Alzheimer, which affects their cognitive skills, and are referred in step 102 to an appropriate channel for treatment. Healthy individuals and individuals with MCI (Minimal Cognitive Impairment), which are referred to henceforth as “substantially mentally healthy individuals” are directed to an appropriate cognitive skill development program in step 104. The appropriate program is then administered to each individual in step 106. Healthy individuals may further be provided with additional activities in step 108. The flow chart continues with reference to only these healthy individuals.

The direction to (or enrollment in) an appropriate cognitive training program in step 104 is preferably based on criteria such as the individual's profession, level of education, health status (e.g. individuals with MCI will be in a special separate group) and free time (for example, it is expected that working people will come in the afternoon while retired people will come in the morning). The training program preferably includes both group training and individual training, which are explained in more detail below. Exemplarily, the group training may include a number of different activities such as workshops for creating challenging interactions (“interaction workshops”), memory training workshops, creativity workshops, social games workshops and lectures. Exemplarily, individual training, which may be carried on in parallel with the group training may include training in a guided manner on cognitive developing software, a physical exercise workshop and a consultation with a nutritionist. Following step 106, healthy individuals are provided with additional activities in step 108. These activities may include time-management workshops, information management workshops, physical training, counseling, foreign language studies and more. Older people may partake in a therapeutic group geared toward acceptance of aging.

The progress of each individual will be monitored periodically for the group work and continuously for the individual computer-based work. The periodical monitoring may include periodic tests such as client satisfaction tests, self-reporting of cognitive skills in day-to-day life, and a yearly repeat of the neurologist general test for each individual. The results of these tests will be used to reevaluate all aspects of the cognitive training program.

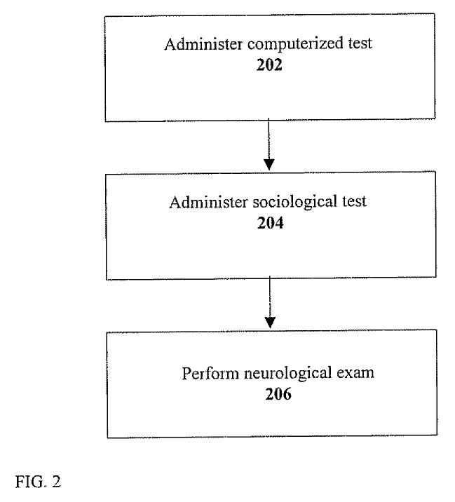

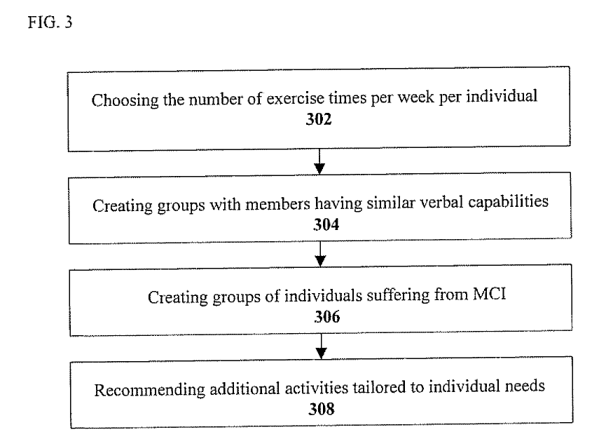

Some of the key steps of the method are now described in more detail with reference to FIGS. 2 and 3.

### Evaluation Step 100

As shown in FIG. 2, the evaluation stage for each potential member includes preferably three sections or parts: a) a computerized test 202 preferably based on software such as NexAide (hereinafter the “NexAide test”) developed by Nexsig Neurological Examination Technologies Ltd., 1 Leshem St, P.O Box 720 Kiryat-Gat 8200, Israel); b) a sociological test 204 preferably based on a written questionnaire developed by Dr. Daniel Gottlieb (hereinafter the “Gottlieb test”) for “Noam, Services for the Golden Age”, 3, Hashloslia Rd. Tel Aviv, Israel; and a neurological diagnostic exam 206. The evaluation has three objectives: a) the creation of a personal training program of every potential member; b) the establishment of a baseline for every member that will enable measurement of progress; and c) detection of people suffering from MCI for creating a special treatment program for them, d) detection of people suffering from the first stage of dementia, in order to direct them to a proper treatment. The follow-up as a result of the three part evaluation was marked as steps 102 and 104 above.

### Choosing Cognitive Training Program Step 104

As shown in FIG. 3, step 104 includes choosing the number of times recommended for each individual to exercise every week (302), using a level of education criterion to create groups with individuals having the same verbal capacities (304), grouping together individuals suffering from MCI (306) and recommending additional activities depending on the needs of each individual (308). The latter may involve time and information managements for busy people and therapeutic groups for those who need therapy.

### Cognitive Training Program Step 106

As mentioned, the training program preferably includes both individual training and group training. The individual training is used to improve memory, attention, and concentration, and is preferably based on a unique software program named “Mindfit” (hereinafter the “Mindfit program”) available from CogniFit Ltd. POB 283 Yoqneam Ilit, Israel 20692.

The group training is performed in work groups and typically includes verbal activity. This requires a certain level of verbalization which is correlated with educational levels. Therefore, each member is placed into a category according to the level of education as well as his/her availability (in terms of schedule). The group training preferably includes the following activities:

a) Interaction workshops—intellectual stimulation through human interaction. Preferably, these workshops will be based on homogenous groups in terms of education but will vary according to age. An experienced facilitator will typically meet with each group once a week for exemplarily an hour and a half during which time will discuss topics requiring unusual intellectual exertion. During their meetings, the members of the group will also sometimes do neurobics (the latter explained in L. Katz and M. Rubin “Keep your Brain Alive”, Workman Publishing Company, New York USA, 1999). The main idea of this technique is to learn to do simple, physical activities in a different way, apart from the usual routine and use senses other than sight and hearing, to develop new networks of neurons in the brain.

b) Memory training workshops—teaching, mnemonics techniques for improvement of the two main processes of memory—encoding and retrieval.

c) Creativity workshops—for example employing methods used usually for gifted children or any other methods known to enhance creativity.

d) Lectures—given on relevant topics, e.g. the brain, cognitive processes, memory, brain development with age, etc. The idea behind these lectures is that people confront problems better when they have awareness. The lectures can be given within the framework of the institute as a part of the membership fee, or in collaboration with an external body such as a university. The content of some of the lectures will serve as a basis of the discussions of these interaction groups.

### Additional Activities Step 108

The additional activities may typically include:

a) Time-management workshops, preferably designated for working people in high positions that suffer from problems of overflow of information and stimulation. Typically after the age of about 50, such people often mistakenly go to neurologists claiming that they suffer from memory decline, when in reality, the main reason for that decline is stress. In these workshops, people will learn to manage their time more usefully, engage in relaxation techniques, and learn how to use electronic equipment to enhance their memory.

b) Support groups for aging, typically designated for retired people. Each group will preferably be led by a clinical psychologist or a specialist in aging. Its main purpose will be to help and develop the mental health of its participants by aiding them to accept their age. Research shows that depression is one of the main reasons for cognitive decline, and these workshops will aim to confront this tendency towards aging induced depression.

c) Foreign language classes. One of the findings best known for delaying the process of cognitive decline is the learning of a new foreign language. As the elasticity of the brain is based on the ability to create an infinite number of circles of connections, and especially the creation of newer circles that existed in the past, learning a foreign language answers this in the best possible way. This is because learning a new language is not only acquiring a vocabulary but also a different grammar structure, and a new way of thinking.

d) Physical exercise based on relaxation, typically including activities such as Tai-chi, Pilatis, yoga, etc, which are known to improve the physical condition as well as mental health.

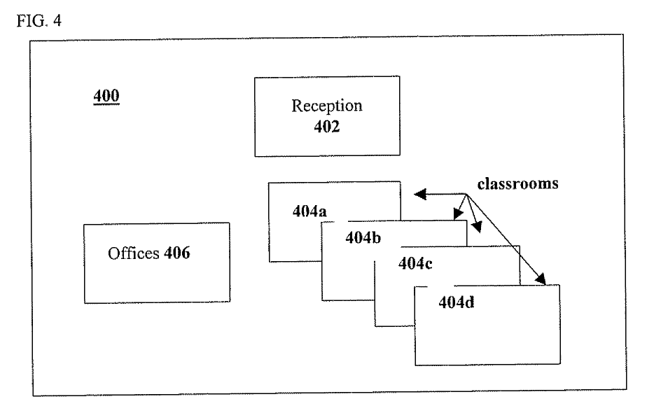

A brain spa of the present invention may preferably be located in a physical facility that resembles a regular (physical or health) spa, except that its essential function is focused on the brain and mental health instead of the body and physical health. It may include some or all the functions existing in health spas, and has the appropriately trained personnel to carry out the various evaluation, selection, administering and training tasks. FIG. 4 shows an exemplary brain spa 400 that includes a reception area 402, various rooms 404a-d and offices 406. Rooms 404 may include one or more computer rooms 404a used for computer related training, one or more classrooms 404b used for non-computer training activities, one or more physical fitness rooms 404c used for physical training activities, one or more clinical testing rooms 404d used for clinical evaluations. In some embodiments, the brain spa may be located in a single physical location having all the elements listed above. In other embodiments, the elements may be divided between two or more physical locations. It is to be understood that each element described by its functionality above may have all the necessary equipment and facilities, including telecommunications, visual aids, etc. needed to perform the tasks described in detail above.

### EXAMPLE

The following example provides a scenario of activity for a new member of the brain spa. The new member will pass an evaluation process that will help in creating a personal exercise program according to his level of education and availability. The evaluation process will exemplarily include the Nexsig test, the social test and the clinical examination. The member will arrive at the institute one's or twice a week: once for a first session of individual/group work lasting between an hour and an hour and a half and once a week for a second session of additional activity. The first session will be divided into an individual session part and a group session part. The individual session part will include a computerized exercise of between 20-30 minutes in a computer lab, performed before or after the group session part. The second session will include physical exercise. Once a month, the member will meet with a nutritionist to evaluate his/her diet. If he/she chooses to participate in additional activities offered by the institute, he/she will participate in time management workshop and/or support groups and/or language classes. The effectiveness of the sessions will be tested periodically using personal subjective evaluations and objective neurologist tests like the one that they have passed in the entry.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made

What is claimed is:

1. A method for improving human brain activity of individual persons to confront aging comprising the steps of:
a. for each individual, evaluating existing cognitive skills to identify substantially mentally healthy individuals;
b. referring each substantially healthy individual to an appropriate cognitive skill training program;
c. administering to each substantially healthy individual the respective appropriate cognitive training program to improve a respective individual brain activity; and, optionally
d. providing each substantially healthy individual with additional activities to improve general health being.

2. The method of claim 1, wherein the step of evaluating includes:
i. administering a computerized test;
ii. administering a sociological test, and
iii administering a neurological diagnostic exam.

3. The method of claim 2, wherein the administering a computerized test includes administering the NexAide test.

4. The method of claim 2, wherein the administering a sociological test includes administering a Gottlieb test.

5. The method of claim 1, wherein the step of referring includes:
i. choosing a number of exercise times per week per individual,
ii. creating groups with members having similar verbal capabilities,
iii. creating groups of individuals suffering from minimal cognitive impairment, and
iv. recommending additional activities tailored to individual needs.

6. The method of claim 1, wherein the step of administering the respective appropriate cognitive training program includes administering a program selected from the group of an individual cognitive training program, a group cognitive training program and a combination thereof.

7. The method of claim 6, wherein the administering an individual cognitive training program includes administering a Mindfit program

8. The method of claim 6, wherein the administering a group cognitive training program includes administering at least one activity selected from the group consisting of an interactive workshop, a memory training workshop, a creativity workshop and a lecture.

9. The method of claim 1, wherein the step of providing each substantially healthy individual with additional activities includes providing each substantially healthy individual with at least one activity selected from the group of a time-management workshop, a support group for aging activity, a foreign language teaching activity and a physical exercise activity.

10. A system for improving human brain activity of individual persons to confront aging comprising a physical facility operative to provide cognitive training.

11. The system of claim 10, wherein the physical facility includes a central facility appropriately equipped to perform, for each individual person, cognitive skill evaluation, referral to an appropriate cognitive skill training program and administration of the chosen respective cognitive training program and additional activities.

12. The system of claim 11, wherein the central facility includes a reception area, rooms appropriately fitted to carry out evaluation, referral, administration and training activities, and offices.

13. The system of claim 10, wherein the central facility is further operative to evaluate existing cognitive skills to identify substantially mentally healthy individuals.

14. The system of claim 14, wherein the evaluation includes a computerized test, a sociological test and a neurological diagnostic exam.
